(19) United States
(12) Patent Application Publication
(10) Pub. No.: US 2002/0158183 A1
(43) Pub. Date: Oct. 31, 2002

(54) Mold structure for plastic art, manufacturing method thereof, and plastic art

(76) Inventor: Tomio Kobayashi, Shiogama-city (JP)

Correspondence Address: Tomio Kobayashi, Kaedecho 3-6-6, Shiogama-city, Miyagi, 985-0084, JP

(21) Appl. No.: 09/842,377

(22) Filed: Apr. 25, 2001

(51) Int. Cl. B29C 33/40; B29C 33/56

(52) U.S. Cl. 249/114.1; 249/134; 428/16

(57) ABSTRACT

This invention offers the new molds assembly structure for a plastic art, which enables the both of the complicated design molding process and low material cost of the mold for mass-production by applying the inner silicone rubber portion and the outer plaster portion.

### BACKGROUND OF THE INVENTION

1. Field of the Invention

This invention relates to the mold, which is used in a so-called plastic art and an ornament made by using the mold.

2. Prior Art

The mold used for the production of pottery and porcelain doll are usually made of plaster and it is necessary to separate the plaster mold parts into several pieces or much more not to be broken on the time of pulling the work out of the mold. The number of the separated mold parts are large for the complicated design of the art and it gives a higher cost of many molds making, many casting processes and assembly process of the molded parts.

On the other hand, the soft resin mold were proposed for the production of complicated figures or inverse tapered section shape figures. Especially, the silicone rubber is the famous resin material for the mold of complicated design and useful to pull the work out of the mold without breaking the work itself and the mold. The silicone rubber mold is also useful because of the good de-molding characteristics from the work materials such as urethane rubber, acrylic acid resin and epoxy resin. We can see these examples in U.S. Pat. Nos. 6,010,655 and 5,824,075. Though the silicone rubber is the good material for the complicated design mold, the higher cost of the silicone material is a problem and about 5 to 10 times more expensive than the plaster of Paris compared as the same volume.

Even though the cost of plaster mold material is low, the complicated design requires the many separated mold parts and results in the total higher cost with each part processing and total mold parts assembly. Related with these situations, the new low cost method was sought for the production of complicated design mold. This tendency has been increasing more and more together with the necessity of the diversification of the figure design for various users' taste.

The U.S. Pat. No. 6,010,655 disclosed the method of the mold structure for a ceramic ornament having short undercuts on surface thereof. It offered the way to make the mold having the short undercuts on the surface by combining the plaster and the silicone rubber material. It characterized the mold to use the thin silicone rubber layer with short under cut all over the figure surface and the thick plaster portion all over the outside of the silicone layer. It also characterized to dry the wet cast work of the figure from the inner side surface of the shell type figure by absorbing the water to the other inner surface plaster mold.

However, when we apply the U.S. Pat. No. 6,010,655 onto the uneven surface or bumpy section design of ornament, it gives the detachment of the thin silicone rubber material layer from the thick plaster portion at the interface. As the silicone rubber material has a comparatively weak adherence to the plaster, the silicone rubber surface layer is easily peeled off the plaster surface especially on the round and smooth surface as shown in the FIG. 7. In fact, when the silicon layer is coated on the precise and complicated surface of original form, the dried surface of silicone rubber layer is always smooth to bury the surface unevenness of original form. This kind of detachment of silicone rubber layer could not be avoided because of the nature of the silicone rubber material.

### OBJECT AND SUMMARY OF THE INVENTION

It is, therefore, an object of the present invention to provide a mold with lower cost compared to the full silicone rubber mold in the condition of the same material volume, and a plastic art made by using the mold. It is another object of the present invention to provide a mold which can be applicable to an uneven surface and bumpy section design of plastic art without the detachment of silicone rubber portion from the plaster mold portion.

In order to accomplish the above objects, intense research on the mold structure design and the molding process has been conducted. As a result, the inventor found the roughness of the interface between the plaster portion and the silicone rubber portion largely contributes to a sure molding process and the complete pulling out process of the work from the mold without breaking the shape and the detachment of both mold materials. The inventor has also found the good design rule of the both material portions largely contributes to the efficient drying process for the wet cast clay works of the non-shell type and uneven surface plastic art.

The mold invented here has the characteristics that the interface between the plaster portion and the silicone rubber portion has the protruding portion of the silicone rubber. The protuberance of the silicone rubber portion into the plaster portion increases the adhesion strength between the two mold materials. The present invention is more precisely characterized as follows. When we see a section cut perpendicularly to the mold surface, we can measure the special angle θ at a point on the interface, which is the angle between the tangential line to the interface curve of the two mold materials and the perpendicular line to the envelope curve of the interface. The present invention revealed the angle θ should be smaller than 20 degree for a good adhesion strength between the silicone rubber portion and the plaster portion.

The present invention is also characterized by the structure of the interface between two mold materials, which has the hook shaped or the ring shaped protruding portion of the silicone rubber into the plaster portion of the mold.

As the present invention provide a sure and stable interface between the silicone rubber and the plaster, the interface can be allowed to cross the molding space with the direct contact of the plaster mold material to the cast molding material. By designing the interface to cross the wet cast molding material surface of the figure, even in the case of the non-shell structure type figure, the efficient drying of the wet cast molding material can be performed well through the plaster mold portion exposed to the outer air.

By following the present invention, the uneven surface design of the figure can be produced with lower cost and it can be applied not only for ceramic ornaments but also plaster figures, resin plastic ornaments and other plastic arts. Though the present invention uses the silicone and the plaster for the mold materials, the other combination of the two materials with soft resin material in place of the silicone and the hard cement material in place of the plaster can be applied. The combination of the silicone rubber and the cement used for the building wall is an effective one of the material choice for the big figure production because of the mold strength.

### BRIEF DESCRIPTION OF THE DRAWINGS

FIGS. 1, 3, 4, 5, 6, 8, 9 and 10 illustrate steps of the invented method of molding process for plastic art.

FIG. 1 is an illustration of an original form.

FIG. 2 is an illustration of the first silicone rubber portion of the mold by conventional method.

FIG. 3 is an illustration of the first silicone rubber portion of the mold by the present invention.

FIG. 4 is an illustration of the second silicone rubber portion of the mold by the present invention.

FIG. 5 is an illustration of the assembled mold parts of the first and the second silicone rubber mold portions of the invention.

FIG. 6 is an illustration of the assembled mold parts of the first and the second silicone rubber mold portions with the first plaster mold portion of the invention.

FIG. 7 is an illustration of the third silicone rubber portion of the mold by the conventional method.

FIG. 8 is an illustration of the third silicone rubber portion of the mold by the present invention.

FIG. 9 is an illustration of the assembled molds with the first silicone rubber, the second silicone rubber, the third silicone rubber and the first plaster mold portions of the invention.

FIG. 10 is an illustration of the assembled molds with the first silicone rubber, the second silicone rubber, the third silicone rubber, the first plaster and the second plaster mold portions of the invention.

FIGS. 11, 12, 13, 14, 15, 16, 17, 18 and 19 illustrate the section views of the molds and the plastic art along with the steps in accordance with the first embodiment of the present invention.

FIG. 11 is the section view of the first silicone rubber mold portion and the original form of the invention.

FIG. 12 is the section view of the first and the second silicone rubber mold portions with the original form and the weirs.

FIG. 13 is the section view of the first silicone rubber, the second silicone rubber and the first plaster mold portions with the original form and the weirs.

FIG. 14 is the section view of the first silicone rubber, the second silicone rubber, the third silicone rubber and the first plaster mold portions with the original form.

FIG. 15 is the section view of the first silicone rubber, the second silicone rubber, third silicone rubber and the first plaster mold portions with the original form and the other weirs.

FIG. 16 is the section view of the first silicone rubber, the second silicone rubber, the third silicone rubber, the first plaster and the second plaster mold portions with the original form and the other weirs.

FIG. 17 is the section view of the first silicone rubber, the second silicone rubber, the third silicone rubber, the first plaster and the second plaster mold portions with the molded plaster figure in accordance with the first embodiment of the present invention.

FIG. 18 is the section view of the de-molded plaster figure and the three parts of the molds in accordance with the first embodiment of the present invention.

FIG. 19 is the section view of the completed plaster figure of the invention.

FIG. 20 illustrates the section views of the molds and the molded figure by the conventional method.

FIG. 21 illustrates the section view of the de-molded plaster figure and the three de-molded mold parts by the conventional method.

FIG. 22 is the section view of the de-molded plaster figure and the three portions of the de-molded mold parts in accordance with the second embodiment of the present invention.

FIG. 23 illustrate the test pieces of the silicone rubber mold portion.

FIG. 24 is a section view of the test pieces of the silicone rubber mold portion.

FIG. 25 is an illustration of the test pieces of the mold part with the silicone rubber mold portion and the plaster mold portion.

FIG. 26 is an illustration of the hooks used for the test pieces of the silicone rubber mold portion and the plaster mold portion.

### DETAILED DESCRIPTION OF THE INVENTION

The present invention will be described hereinafter in more detail.

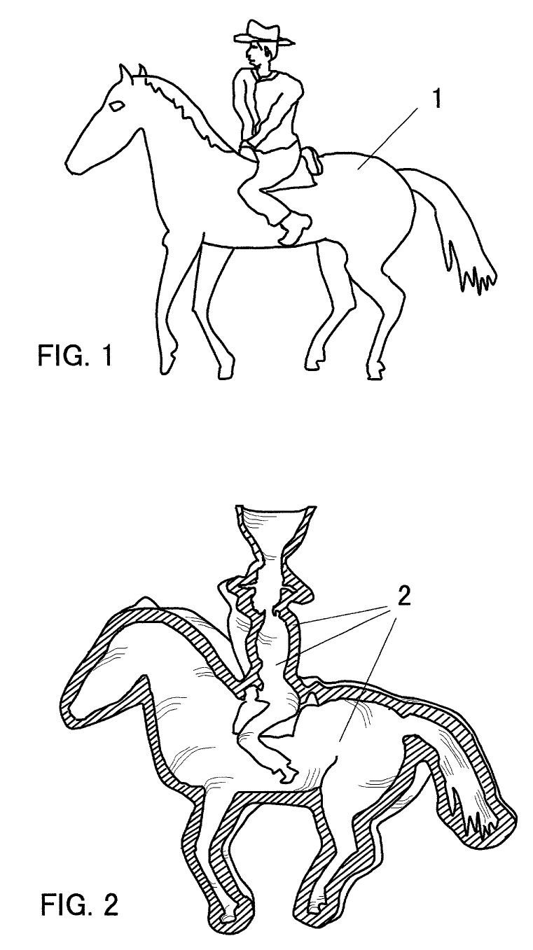

FIG. 1 is an illustration of the original form 1 made in clay. The processes in accordance with the invention are explained together with the drawings as follows. The original form was made with the rough size of 200 mm height.

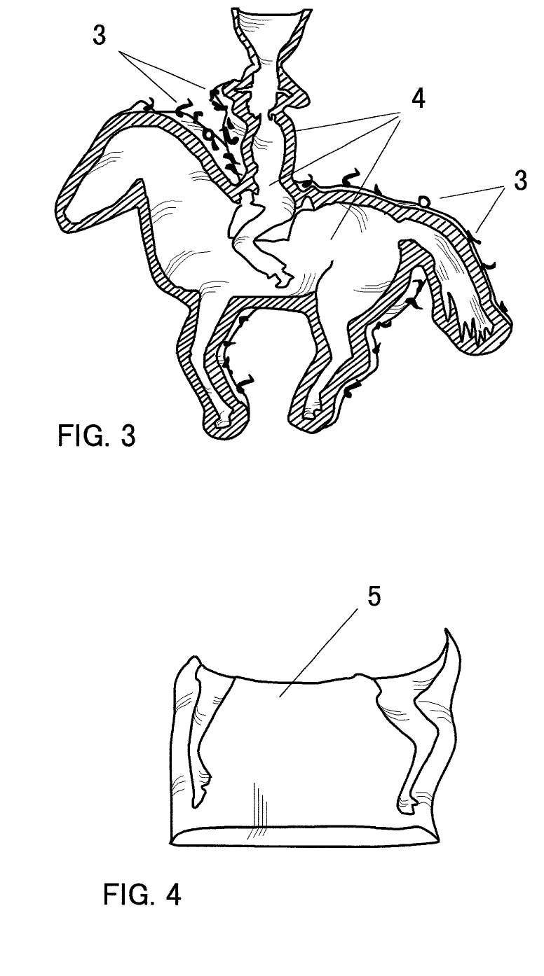

Firstly the soft silicone rubber paste was coated with the thickness of 3 to 4 mm on the half surface of the original form. After drying the silicone rubber, the dried and hardened silicone rubber layer was peeled off the original form. The silicone rubber layer could be peeled off without break or tear because of the adequate flexibility of its material feature. The silicone rubber could also copy the surface shape of the original form very well. This first portion of the silicone rubber mold portion 2 by the conventional method is illustrated in FIG. 2. However, the outer surface of the silicone rubber mold portion 4 was added the protuberances 3 in the present invention as shown in the FIG. 3. These protuberances 3 were made by adding the protruding portions of the silicone rubber paste before drying.

After peeling off the first portion of the silicone rubber mold part, the original form was set inside of its silicone rubber mold part again. Then, the new silicone rubber paste was coated and filled up inside the four legs of the horse of original form. This silicone rubber portion 5 surrounded by the four legs could be formed by filling the silicone rubber paste little by little with its drying. The outer shape of this second silicone rubber portion 5 of the mold was formed to make the smooth surface except the leg surface as shown in FIG. 4. The protuberances were not added over this second silicone rubber mold portion 5 because of the total molds design consideration. The under coating of the very thin hand cream or oily paste on the first silicone rubber mold portion and the original form was very useful to promote the easy peeling off the second silicone rubber mold portion 5 from the first silicone rubber mold portion 4.

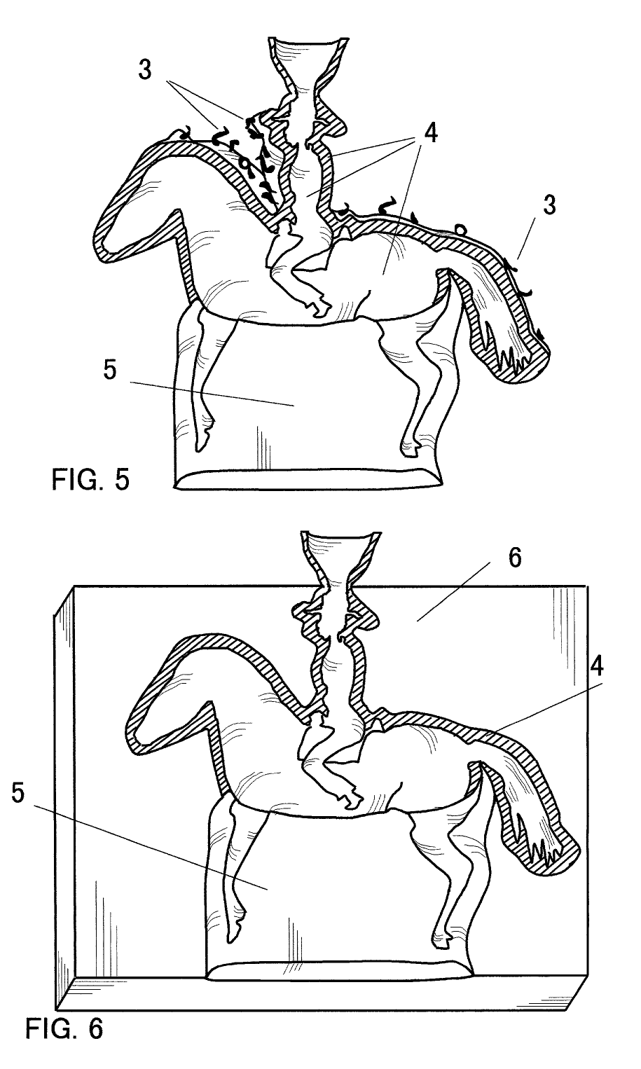

FIG. 4 illustrates the second portion 5 of the silicone rubber mold part after taking out from the first silicone rubber mold portion and the original form in the invention. After peeling off the second portion 5 of the silicone rubber mold, the first and the second silicone rubber mold portions were assembled again as shown in FIG. 5. In this process, the original form can be set together with the first and second silicone rubber mold portions to make sure the shape of the first silicone rubber mold layer.

In the next process, the water mixed plaster of Paris was poured over the outer side surface of the first silicone rubber mold and the second silicone rubber mold as shown in FIG. 6. The outer side surface of the first plaster mold portion can be imagined almost at the back side face of FIG. 6. When the water mixed plaster of Paris was poured, the weirs were used and are illustrated in the other pages for section view explanation of this specification. The first plaster mold portion 6 is very surely connected with the first silicone rubber mold portion by the protuberances 3.

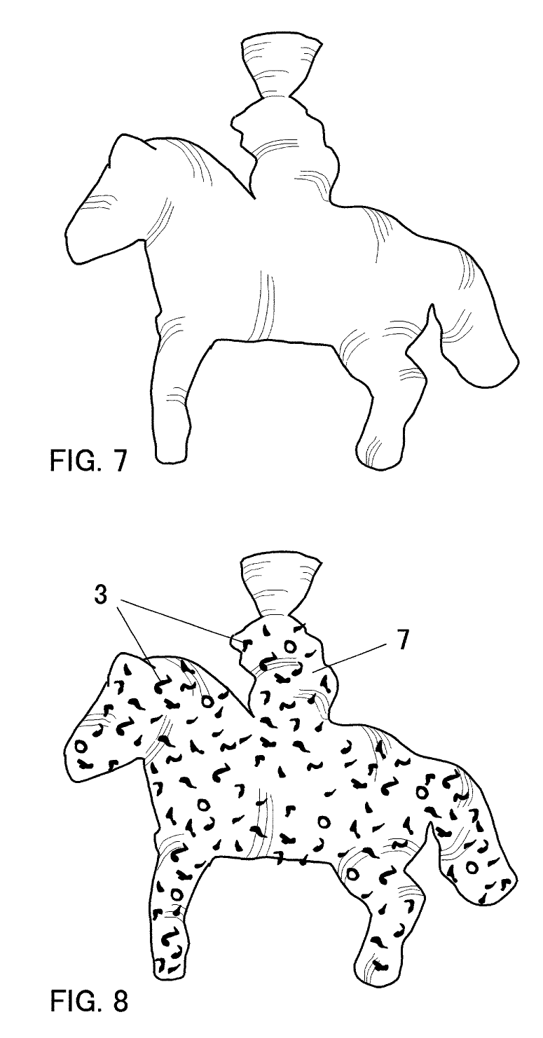

In the next process, the original form, the first silicone rubber mold portion connected with the first plaster mold portion and the second silicone rubber mold portion were assembled again by following the orientation as same as the one in which the mold parts had been made. Then, the silicone rubber paste was coated over the exposed surface portion of the original form. After drying this silicone rubber paste, the peeled off silicone rubber layer was named as the third silicone rubber mold portion. FIG. 7 shows the third silicone rubber mold portion by conventional method. FIG. 8 shows the third silicone rubber mold portion 7 with the surface protuberances 3 of the silicone rubber by following the present invention.

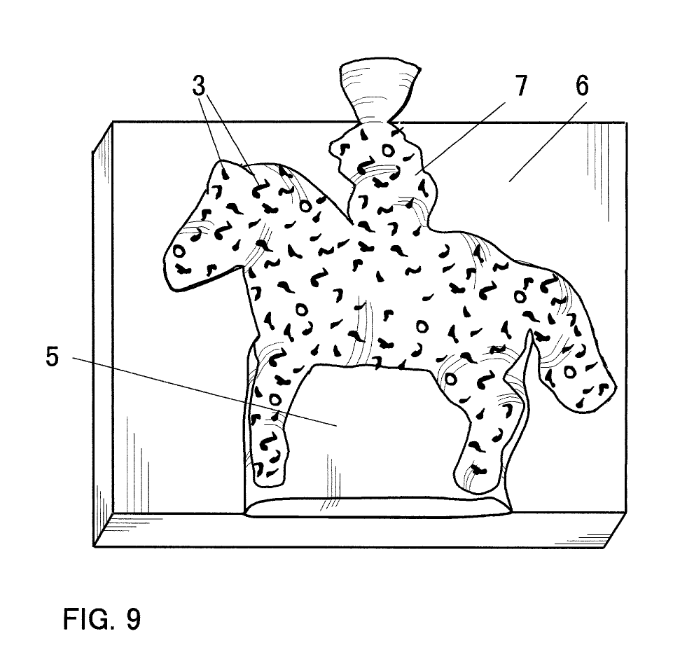

In order to pour the water mixed plaster of Paris over the third silicone rubber mold portion 7, the third silicone rubber mold portion 7 was set on the assembled first silicone rubber, the second silicone rubber and the first plaster mold portions as shown in FIG. 9. In this process, the original form can be set together with the other mold portions to make sure the shape of the third portion of the silicone rubber mold. The weirs were used for making the square shape of the second plaster mold 9 and are shown in the section view explanation pages of the present invention.

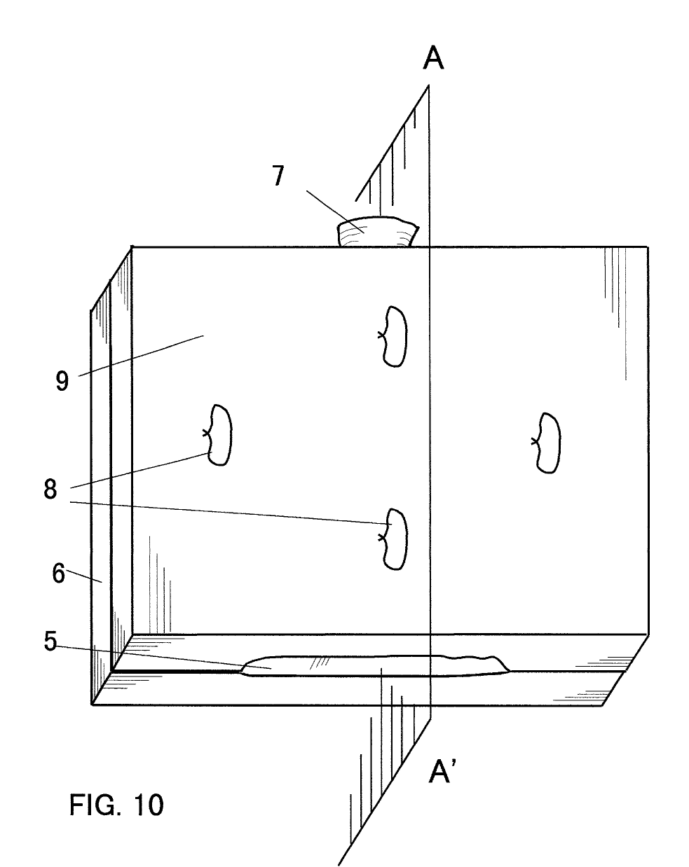

The rounded steel wires 8 were set half inside the water mixed plaster of Paris to make the drawer pulls for the de-molding process as shown in FIG. 10. After solidifying the second plaster mold portion 9, the second plaster mold portion and the third silicone rubber mold portion were surely connected by the protuberances 3.

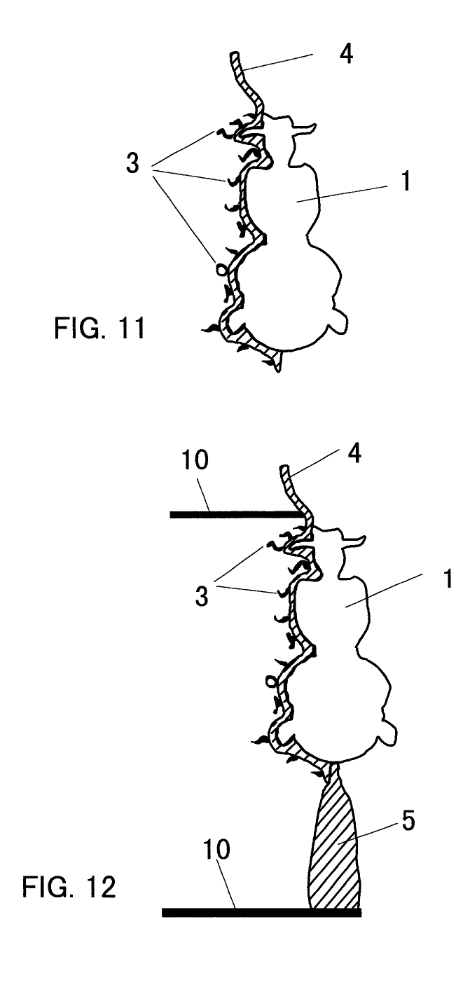

The more detailed processes of the mold parts making are explained here by using the section views in FIGS. 11 to 22. The cutting plane for the section view is applied for the AA′ plane shown in FIG. 10.

FIG. 11 shows the section view for making the first silicone rubber mold portion 4. The first silicone rubber mold portion 4 was formed on the original form 1 surface and had the many protuberances 3 of silicone rubber.

FIG. 12 shows the preparation of the weirs 10 for pouring the water mixed plaster of Paris over the first silicone rubber mold portion 4 and the second silicone rubber mold portion 5 to make the first plaster mold portion. In order to make the square shape of the first plaster mold portion as shown in FIG. 6, the weirs 10 were prepared to surround the main portion of the first silicone rubber mold portion and the second silicone rubber mold portion. The casting gate portion of the first mold portion made of silicone rubber was exposed outside the weir. The one side planer surface of the second mold portion made by silicone rubber was contacted with the weir surface plane, too. The bottom plane area except the first and the second silicone rubber mold surfaces was prepared by attaching the plastic film sheet cut along with the vacant area shape except those two silicone rubber mold portions. The temporal plastic film sheet was peeled off and thrown away after solidifying the first plaster mold portion.

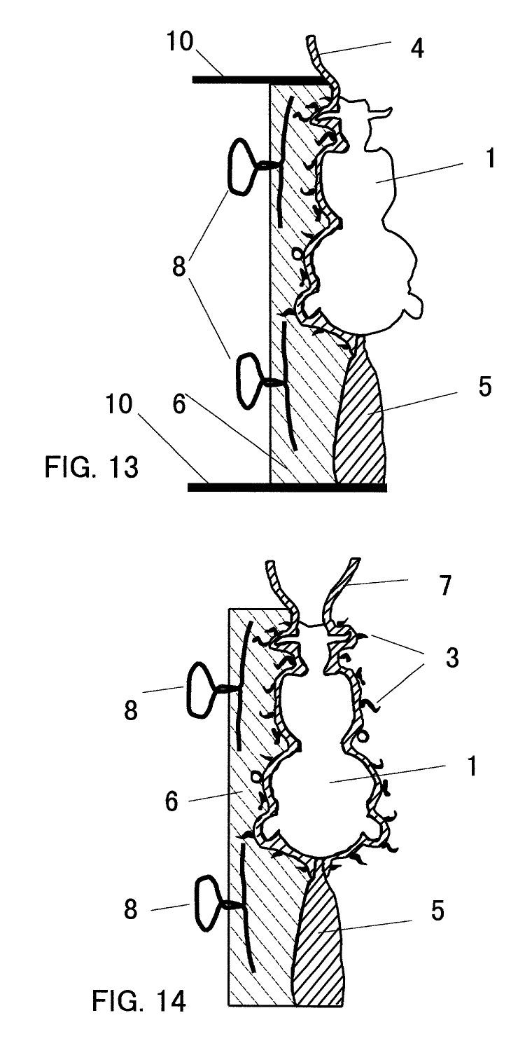

FIG. 13 shows the section view of the first silicone and the second silicone rubber mold portions with the original form and the weirs just after solidifying the first plaster mold portion. The rounded steel wires 8 were half dipped into the water mixed plaster of Paris and solidified. These steel wires 8 were very useful for the de-molding process handling as the drawer pulls.

FIG. 14 shows the section view of the first silicone rubber, the second silicone rubber and the first plaster mold portions with the original form just after making the third silicone rubber mold portion 7 with the many protuberances 3.

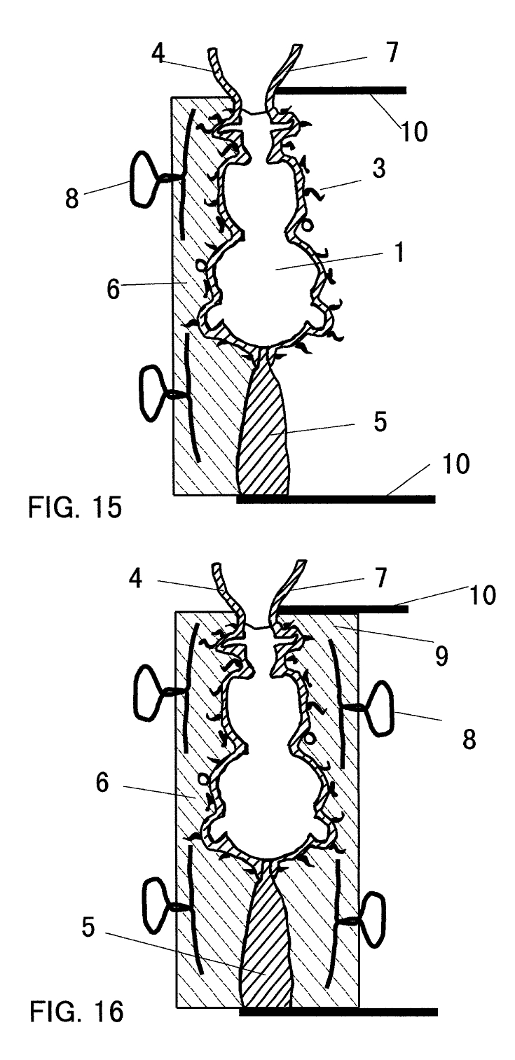

FIG. 15 shows the section view of the weirs 10 prepared for pouring the water mixed plaster of Paris over the second silicone, the third silicone rubber mold portions and the first plaster mold portion connected with the first silicone rubber mold portion. In this process, the original form 1 had been set together to make sure the shape of the third silicone rubber mold portion supported by the original form.

FIG. 16 shows the section view of the molds, original form and the weirs just after solidifying the second plaster mold portion. The rounded steel wires 8 were set inside the water mixed plaster and solidified with the second plaster mold portion as like as the first plaster mold portion. After solidification, all the molds were separated into three parts, namely, the first silicone rubber mold portion connected with the first plaster mold portion, the second silicone rubber mold portion and the third silicone rubber mold portion connected with the second plaster mold portion. Taking out the original form, three parts of the molds were assembled together for molding the figure again.

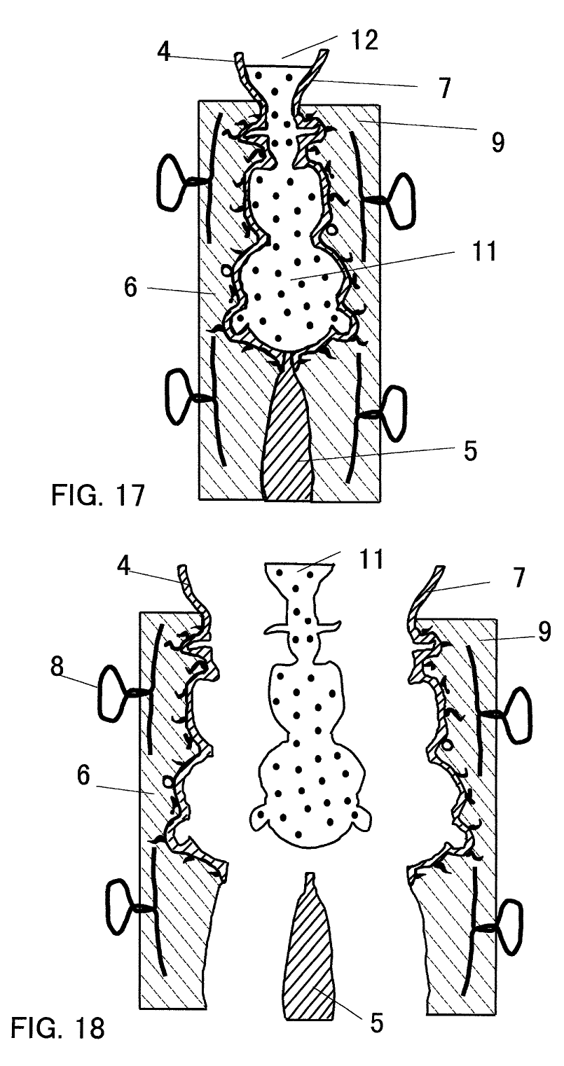

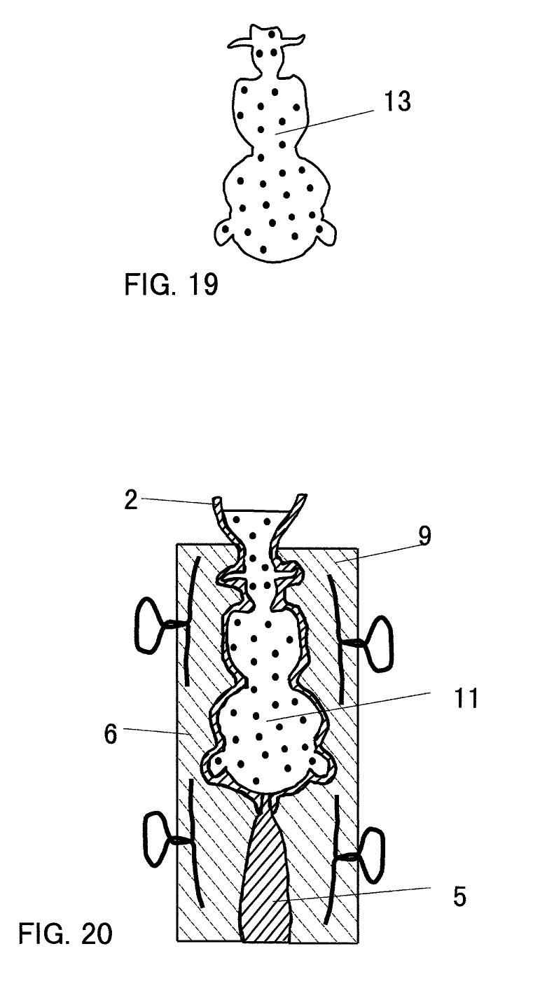

FIG. 17 shows the section view of the molds and the molded FIG. 11. The water mixed plaster of Paris was poured into the molds from the casting gate 12 and then solidified. After de-molding the FIG. 11, all the molds made by the present invention kept the mold shape complete as shown in FIG. 18. The de-molded FIG. 11 was worked to cut off the casting gate portion to make the complete FIG. 13 as shown in the FIG. 19.

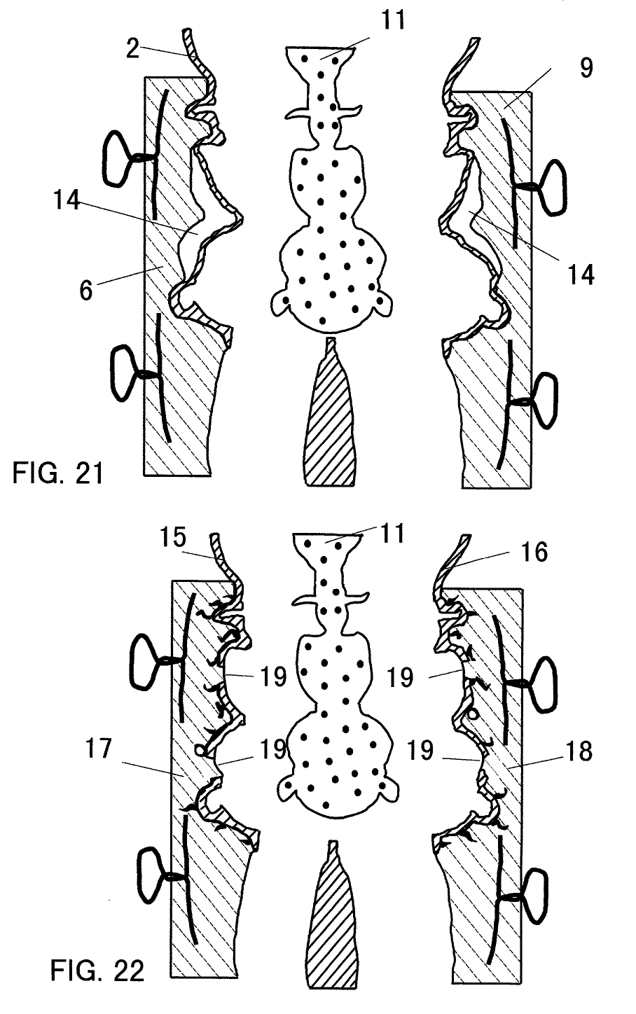

FIGS. 20 and 21 show the conventional method situation. FIG. 20 shows the section view of the molds and the molded figure made by conventional method. As the many protuberances of silicone rubber portion on the interface between the silicone rubber mold portion and the plaster mold portion were not made, the silicone rubber mold portions were peeled off on the time of the de-molding process as shown in FIG. 21. The vacant space 14 made by peeling off of the silicone rubber mold portion from the plaster mold portion was the absolute defect for the usage of the mold because of the different shape from the original form.

As explained above, the protuberances 3 are very effective to keep the complete shape of the mold for many usage of the mold including the de-molding process. By following the present invention, even the complex design figure can be molded by using a few mold parts. In the present invention, as the silicone rubber mold portion and the plaster mold portion are firmly and surely connected, the mold parts assembly and the de-molding process are very easier than the all plaster molds process. On the other hand, the cost of the molds by the present invention is lower than the all silicone molds process. These consistent characteristics were actualized by the present invention.

FIG. 22 shows another embodiment of the present invention. In FIG. 22, the first silicone rubber mold portion 15 and the second silicone rubber mold portion 16 had several penetrating holes 19 on themselves. These penetrating holes enabled the water drying of the cast plaster 11 through these holes to the first plaster mold portion 17 and the second plaster mold portion 18. These holes 19 are very effective to dry the diluted clay with water after casting into the molds.

Explained FIG. 8 or others included various shape of protuberances 3, which were characterized by the words of the string like shapes, curled shapes, S figure shapes, inverse tapered shapes, widen toward the end or ring shapes. These shapes had the same effect of connecting the silicone rubber mold portion and the plaster mold portion very strongly and not to be separated.

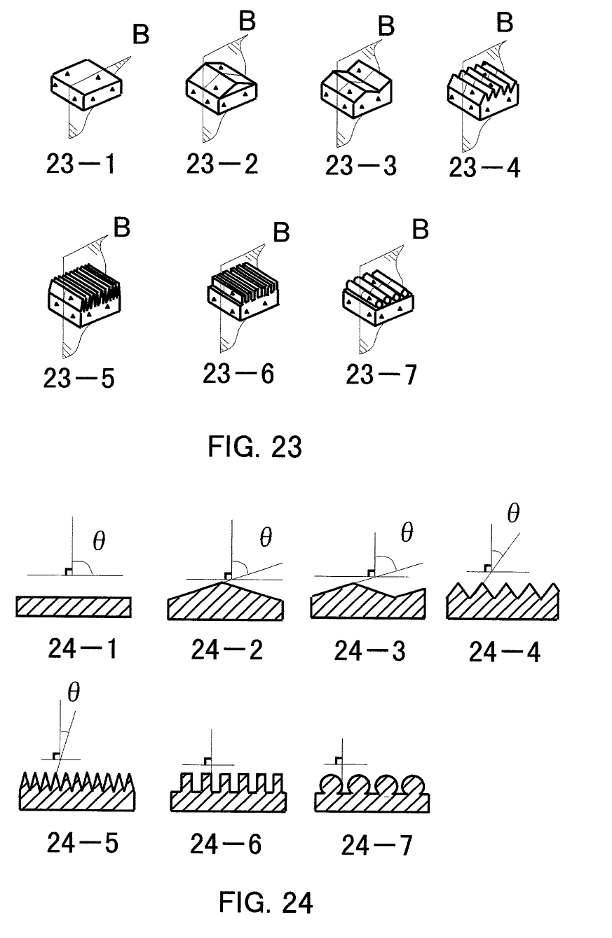

The other embodiment of the invention made clear the shape condition of the protuberances 3 by the fundamental experiments shown in FIGS. 23 to 26. FIG. 23 shows various types of the test pieces for silicone rubber mold portion. These silicone rubber mold portions were formed by using the soft silicone rubber paste before drying and then dried to the each complete shape. Even after being dried, the silicone rubber portion had the enough flexibility. All these test pieces had the horizontal section area of a regular square with 20 mm side length. The each completed shape represents the example of the silicone rubber surface shape on which the water mixed plaster of Paris is poured and dried to become hard along with the silicone rubber surface shape.

These 7 silicone rubber test pieces, 23-1 to 23-7, had been used to pour the water mixed plaster of Paris on the top surface of them. To make clear the shape, each section views observed at the cut plane B of the 7 test pieces are shown in FIG. 24.

Section FIGS. 24-1 to 24-7 shows the each section shape of the silicone rubber test pieces identified by 23-1 to 23-7 number. The shapes are defined by the angle θ between the tangent line of the surface and the perpendicular line to the envelope curve of the surface. In these 7 pieces, the envelope curve of the surface is shown as the line parallel to the bottom line of the silicone rubber test piece.

The angle θ of section 24-1 is 90 degree. The angle θ of section 24-2 and section 24-3 is 70 degree. The angle θ of section 24-4 is 35 degree. The angle θ of section 24-5 is 15 degree. Sections 24-6 and 24-7 show the examples that the minimum angle of θ on the entire surface point is zero degree.

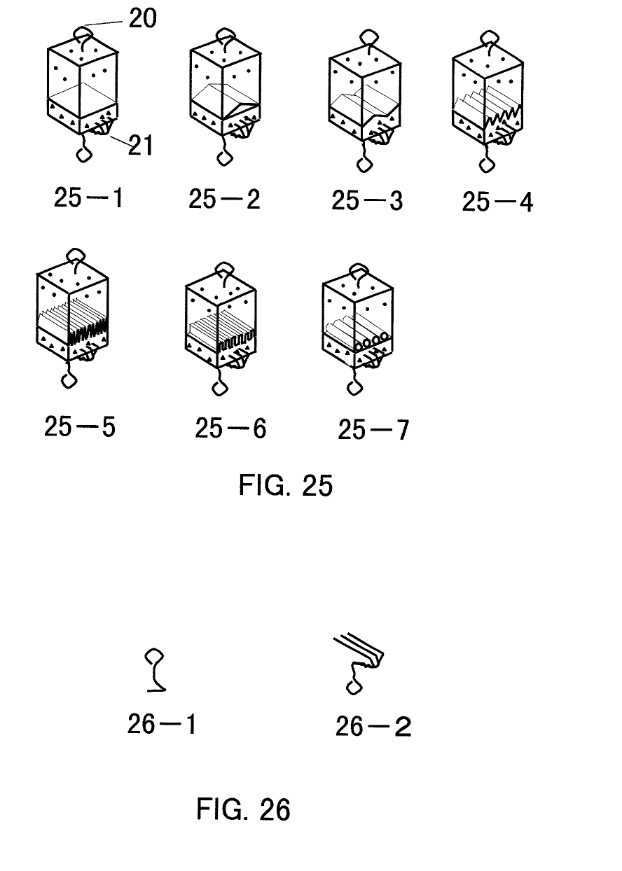

FIG. 25 shows the completed test pieces with the plaster portions, which were poured onto the surface of the silicone test pieces 23-1 to 23-7 and solidified. The four side faces of the silicone rubber portion were faced to the four plane weirs before pouring the water mixed plaster. The water mixed plaster was formed to a rectangular parallelepiped inside the four surrounding plane weirs.

The steel wire hook 20 was set in the water mixed plaster and solidified together. The steel wire hook before setting in the water mixed plaster is shown as 26-1 in FIG. 26.

The steel wire hook 21 for the silicone rubber portion was pierced into a side face of the silicone rubber portion as shown in the 25-1 to 25-7 of FIG. 25. The steel wire hook 21 before piercing into the silicone side face is shown as 26-2 in FIG. 26.

The tension test to measure the adhesion strength between the silicone rubber portion and the plaster portion was performed by pulling the two hooks 20 and 21 in the opposite direction. The adhesion strength was measured by inserting the spring balance between a hook and the pulling arm three times for new test pieces of each type The measured values just before the test piece was broken and separated completely were recorded as follows.

The adhesion strength values for the three test pieces of the type 25-1 were 20,21 and 22 gram per square centimeter.

The adhesion strength values for the three test pieces of the type 25-2 were 21,21 and 23 gram per square centimeter.

The adhesion strength values for the three test pieces of the type 25-3 were 21,22 and 23 gram per square centimeter.

The adhesion strength values for the three test pieces of the type 25-4 were 28,30 and 30 gram per square centimeter.

The adhesion strength values for the three test pieces of the type 25-5 were 250,250 and 260 gram per square centimeter.

The adhesion strength values for the three test pieces of the type 25-6 were 300,320 and 300 gram per square centimeter.

The adhesion strength values for the three test pieces of the type 25-7 were 400,425 and 405 gram per square centimeter.

Comparing these adhesion strength data, it was realized that the adhesion strength between the silicone rubber portion and the plaster portion was very large on the cases with the angle θ smaller than the 20 degree. In another words, the angle θ between the tangent line of the silicone rubber portion surface and the perpendicular line to the envelope curve of the silicone rubber portion surface is very important to keep the higher adhesion strength between the silicone rubber portion and the plaster portion. The smaller angle than 20 degree was the key for the higher adhesion strength.

In the above examples, the adhesion strength measurement was performed for the test piece with the same shape of the section respectively, when cut perpendicularly to an axis. The dear results of the higher adhesion strength in the smaller angle θ than 20 degree is same also in the test pieces which have the different section shape when cut perpendicularly to an axis.

In another words, this result of the higher adhesion strength with the θ under 20 degree was true in the B section plane of the FIG. 23 and also true in the perpendicular plane to the B of the FIG. 23.

By forming the protuberances which have the smaller angle θ than 20 degree in every section plane perpendicular to the envelope curve of the silicone rubber portion surface, the adhesion strength between the silicone rubber portion and the plaster portion can be increased very well.

From these results, it is reasonable to understand that at least in one section plane perpendicular to the envelope surface, the angle between the tangent line of the protuberance surface and the perpendicular line to the envelope curve of the silicone rubber surface should be smaller than 20 degree.

In the above explanations, the actual examples of the present invention were shown. As the various modifications to the examples shown above are possible, those modifications are shown here.

The original form 1 can be made by paper clay, too. The infiltration of molten wax to the dried clay or paper clay is good for actualizing the good peeling of silicone rubber portion from the original form surface in the room temperature. The original form can be made also by wood sculpture.

The plaster portions 6 and 9 of the mold can be made also by fine cement or other material which solidify from a fluid to a solid.

The molded FIG. 11 with plaster is possible to be made also by fine cement and organic resins including epoxy, urethane rubber and others.

The steel wire can be set as a bone in the area surrounded by the silicone rubber portions of the molds before casting the molding fluid.

The rounded steel wire 8 can be made also by the other strong materials including copper, other metal and hard plastic.

The process of the invention can be applied to not only a figure and a doll but also a relief.

What is claimed is:

1. The molds assembly having at least one composite mold part, which have the outer plaster portion and the inner silicone rubber portion, and the silicon rubber portion faces the molding space to be cast a molding material and possesses the protuberances of the silicon rubber surface at the interface between the plaster portion and the silicon rubber portion.

2. The molds assembly of claim 1 comprising the additional feature of silicon rubber protuberances, which are string like shapes, curled shapes, S figure shapes, inverse tapered shapes, widen toward the end or ring shapes.

3. The mold assembly of claim 1 comprising the additional feature of silicon rubber protuberances, which are characterized by that, at least, at one of the point of the protuberance surface, the intersecting angle θ between the tangent plane of the protuberance surface and the perpendicular plane to the envelope surface of the interface between the plaster portion and the silicon rubber portion is smaller than 20 degree.

4. The molds assembly of claim 1 comprising the additional feature of the plaster portion, which has the some areas to expose directly to the molding space without the silicone rubber portion.

5. The plastic art made by using the molds assembly of claim 1, 2, 3 or 4.
